(19) United States
(12) Patent Application Publication
(10) Pub. No.: US 2016/0166462 A1
(43) Pub. Date: Jun. 16, 2016

(54) PERSONAL MASSAGE APPARATUS

(71) Applicant: Richard V. Conder, South Jordan, UT (US)

(72) Inventor: Richard V. Conder, South Jordan, UT (US)

(21) Appl. No.: 14/964,200

(22) Filed: Dec. 9, 2015

Related U.S. Application Data
(60) Provisional application No. 62/090,301, filed on Dec. 10, 2014.
(60) Provisional application No. 62/237,744, filed on Oct. 6, 2015.

(51) Int. Cl. A61H 7/00

(52) U.S. Cl. CPC A61H 7/001

(57) ABSTRACT

A massage apparatus for applying pressure to a body part includes a handle section configured to be positioned on a first side of the body part. The handle section includes a free end and an attached end, and a transverse section configured to extend from the first side of the body part to a second side of the body part. The transverse section includes a first end positionable on the first side of the body part and a second end positionable on the second side of the body part. The first end of the transverse section is coupled to the attached end of the handle section. A pressure point section is configured to apply pressure to the body part. The pressure point section includes a distal end coupled to the second end of the transverse section and an inward tip engageable on the body part.

### CROSS-REFERENCES TO RELATED APPLICATIONS

This application claims the benefit of U.S. Provisional Patent Application No. 62/090,301 entitled “PERSONAL MASSAGE APPARATUS” and filed on Dec. 10, 2014 for Richard V. Conder and claims the benefit of U.S. Provisional Patent Application No. 62/237,744 entitled “PERSONAL MASSAGE APPARATUS” and filed on Oct. 6, 2015 for Richard V. Conder, both of which are incorporated herein by reference for all purposes.

### FIELD

This invention relates to pressure point therapy and more particularly relates to a device to apply pressure to points on the body of a user.

### BACKGROUND

Massage therapy often uses application of pressure to particular areas of the body of a person to relieve pain. Painful locations, such as locations where muscles are tight are sometimes called trigger points, may benefit from application of pressure to the trigger point. Application of pressure often causes muscles to relax, thus relieving pain. Commonly massage therapists use pressure techniques and deep tissue massage to apply pressure to tense muscles to allow the muscles to relax. However, often massage therapy is too expensive for some and can be inconvenient due to time constraints. Self-massage can be used to alleviate pain when a massage therapist is not available for some reason. However, some parts of the body, such as the back, may be difficult to access for self-massage.

### SUMMARY

One embodiment of an apparatus for applying pressure to a body part of a user is disclosed. The apparatus includes a handle section configured to be positioned on a first side of the body part, where the handle section has a free end and an attached end, and a transverse section configured to extend from the first side of the body part to a second side of the body part. The transverse section includes a first end positionable on the first side of the body part and a second end positionable on the second side of the body part, where the first end of the transverse section is coupled to the attached end of the handle section. In the embodiment, the apparatus includes a pressure point section configured to apply pressure to the body part. The pressure point section includes a distal end and an inward tip, where the distal end of the pressure point section is coupled to the second end of the transverse section and the inward tip is engageable on the body part.

In one embodiment, the transverse section includes a bend interposed between two subsections: a first subsection comprising the first end and a second subsection comprising the second end. The second subsection extends from the first subsection at an inward angle. In another embodiment, the inward angle is about 45 degrees. In a further embodiment, the first subsection of the transverse section and the handle section are substantially perpendicular. In another embodiment, the handle section has a length and the inward tip of the pressure point section is disposed a distance perpendicularly away from the first subsection of the transverse section. The length is greater than the distance. In a further embodiment, the length is at least 1.5 times the distance. In another further embodiment, the length is at least 2.0 times the distance.

In one embodiment, the inward tip of the pressure point section is disposed further away, in a direction parallel to the first subsection of the transverse section, from the first end of the transverse section than the bend is from the first end of the transverse section. In another embodiment, the inward tip of the pressure point section is parallel to the first subsection of the transverse section. In another embodiment, the inward tip of the pressure point section is non-perpendicular to the second subsection of the transverse section. In another embodiment, the handle section is perpendicular to the inward tip of the pressure point section. In yet another embodiment, the apparatus includes a pivoting joint mechanism intercoupled between the attached end of the handle section and the first end of the transverse section, where the pivoting joint mechanism is configured to allow the user to select an angle between the handle section and the transverse section.

Another embodiment of the present invention includes a massage apparatus for applying pressure to a body part of a user. The apparatus includes a handle section configured to be positioned on a first side of the body part. The handle section includes a free end and an attached end. The apparatus includes a transverse section configured to extend from the first side of the body part to a second side of the body part. The transverse section includes a first end positionable on the first side of the body part and a second end positionable on the second side of the body part. The apparatus includes a pivoting joint mechanism intercoupled between the attached end of the handle section and the first end of the transverse section. The pivoting joint mechanism is configured to allow the user to select an angle between the handle section and the transverse section.

In the embodiment, the apparatus includes a pressure point section configured to apply pressure to the body part. The pressure point section includes a distal end and an inward tip, where the distal end of the pressure point section is coupled to the second end of the transverse section and the inward tip is engageable on the body part. The pressure point section includes a bend interposed between two subsections: a first subsection comprising the first end and a second subsection comprising the second end. The second subsection extends from the first subsection at an inward angle. The handle section includes a length and the inward tip of the pressure point section is disposed a distance perpendicularly away from the first subsection of the transverse section, where the length is greater than the distance. The inward tip of the pressure point section is disposed further away, in a direction parallel to the first subsection of the transverse section, from the first end of the transverse section than the bend is from the first end of the transverse section.

In one embodiment, the apparatus includes a joint detachably coupling the transverse section to the pressure point section. In another embodiment, the joint includes a release mechanism, where engaging the release mechanism releases the transverse section from the pressure point section. In another embodiment, the joint includes a coupling mechanism that detachably couples the pressure point section at various angles with respect to a plane extending through the transverse section and the handle section. In another embodiment, the apparatus includes a plurality of pressure point sections, where each pressure point section includes a different inward tip. In another embodiment, the apparatus includes a tip coupling joint and a plurality of different inward tips, where each inward tip is coupleable to the pressure point section at the tip coupling joint. In a further embodiment, an inward tip of the plurality of inward tips includes one or more of a temperature controlled inward tip, a vibrating inward tip, a pointed tip, a soft tip and/or a rounded tip.

Another embodiment of a massage apparatus for applying pressure to a body part of a user is described. The apparatus includes a handle section configured to be positioned on a first side of the body part, where the handle section comprising a free end and an attached end, and a transverse section configured to extend around from the first side of the body part to a second side of the body part. The transverse section includes a first end positionable on the first side of the body part and a second end positionable on the second side of the body part. The transverse section includes a bend interposed between two subsections: a first subsection comprising the first end and a second subsection comprising the second end, where the second subsection extends from the first subsection at an inward angle. The apparatus includes a pivoting joint mechanism intercoupled between the attached end of the handle section and the first end of the transverse section. The pivoting joint mechanism is configured to allow the user to select an angle between the handle section and the transverse section.

The apparatus includes a pressure point section configured to apply pressure to the body part. The pressure point section includes a distal end and an inward tip. The distal end of the pressure point section is coupled to the second end of the transverse section and the inward tip is engageable on the body part. The handle section includes a length and the inward tip of the pressure point section is disposed a distance perpendicularly away from the first subsection of the transverse section, where the length is greater than the distance. The inward tip of the pressure point section is disposed further away, in a direction parallel to the first subsection of the transverse section, from the first end of the transverse section than the bend is from the first end of the transverse section.

In one embodiment, the apparatus includes a joint detachably coupling the first subsection of the transverse section to the second subsection of the transverse section. In another embodiment, the joint includes a release mechanism, where engaging the release mechanism releases the first subsection of the transverse section from the second subsection of the transverse section. In another embodiment, the apparatus includes a coupling mechanism that detachably couples the second subsection to the first subsection at various angles with respect to a plane extending through the first subsection of the transverse section and the handle section. In another embodiment, the apparatus includes a plurality of pressure point sections, where each pressure point section comprising a different inward tip. In another embodiment, the apparatus includes a tip coupling joint and a plurality of different inward tips, where each inward tip is coupleable to the pressure point section at the tip coupling joint. In a further embodiment, an inward tip of the plurality of inward tips includes a temperature controlled inward tip, a vibrating inward tip, a pointed tip, a soft tip and/or a rounded tip.

Another embodiment of a massage apparatus for applying pressure to a body part of a user includes a handle section configured to be positioned on a first side of the body part, where the handle section comprising a free end and an attached end, and a transverse section configured to extend from the first side of the body part to a second side of the body part. The transverse section includes a first end positionable on the first side of the body part and a second end positionable on the second side of the body part. The transverse section includes a bend interposed between two subsections: a first subsection comprising the first end and a second subsection comprising the second end, where the second subsection extends from the first subsection at an inward angle. The apparatus includes a pivoting joint mechanism intercoupled between the attached end of the handle section and the first end of the transverse section, where the pivoting joint mechanism is configured to allow the user to select an angle between the handle section and the transverse section.

In the embodiment, the apparatus includes a pressure point section configured to apply pressure to the body part, where the pressure point section has a distal end and an inward tip. The inward tip is engageable on the body part, and the inward tip of the pressure point section is parallel to the first subsection of the transverse section. The apparatus includes a joint detachably coupling the first subsection of the transverse section to the second subsection of the transverse section. The handle section includes a length and the inward tip of the pressure point section is disposed a distance perpendicularly away from the first subsection of the transverse section, where the length is greater than the distance. The inward tip of the pressure point section is disposed further away, in a direction parallel to the first subsection of the transverse section, from the first end of the transverse section than the bend is from the first end of the transverse section.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1A is a side view of one embodiment of a massage apparatus for applying pressure to a body part of a user;

FIG. 1B is a side view of another embodiment of the massage apparatus for applying pressure to the body part of the user;

FIG. 2 is a side view of one embodiment of the massage apparatus positioned around the body part of the user;

FIG. 3 is a side view of another embodiment of the massage apparatus positioned around the body part of the user;

FIG. 4 is a side view of another embodiment of the massage apparatus positioned around the body part of the user;

FIG. 5 is a side view of another embodiment of the massage apparatus positioned around the body part of the user;

FIG. 6 is a side view of yet another embodiment of the massage apparatus positioned around the body part of the user; and

FIG. 7 is a side view of another embodiment of the massage apparatus for applying pressure to the body part of the user.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

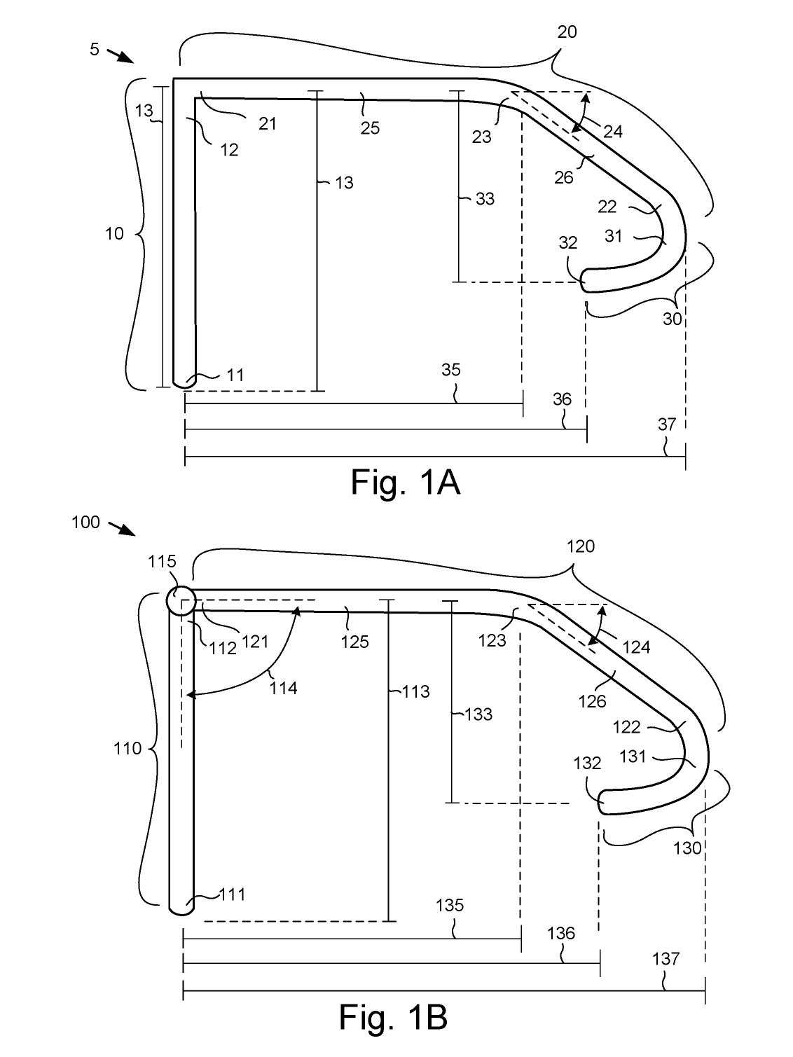

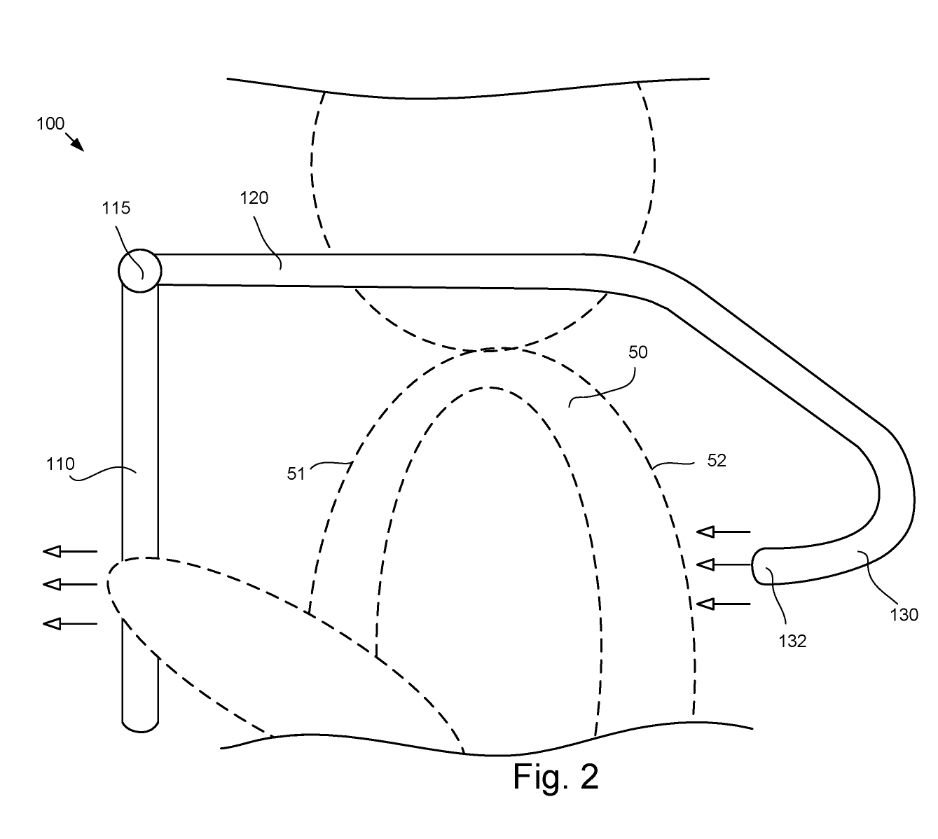

FIG. 1A is a side view of one embodiment of a massage apparatus 5 for applying pressure to a body part of a user. The massage apparatus 5 includes a handle section 10, a transverse section 20, and a pressure point section 30. Generally, the handle section 10 is the portion of the apparatus 5 that is grasped by the user during use of the apparatus. The handle section 10 includes a free end 11 and an attached end 12. The transverse section 20 is the portion of the apparatus 5 that extends around the body part of the user that is to be massaged. The transverse section 20 includes a first end 21 and a second end 22. The attached end 12 of the handle section 10 is coupled to the first end 21 of the transverse section 20. The massage apparatus 5 further includes a pressure point section 30. The pressure point section 30 is the portion of the apparatus 5 that is directed towards and engages with a surface of the body part being massaged. Specifically, the pressure point section 30 includes a distal end 31 and an inward tip 32. The second end 22 of the transverse section 20 is coupled to the distal end 31 of the pressure point section 30. The inward tip 32 is the element that contacts and applies pressure to the body part when the user grasps the handle section and applies a force to the apparatus 5. In one embodiment, the handle section 10 the transverse section 20 and the pressure point section 30 are all coplanar or substantially coplanar. Further details relating to the function and/or operation of the massage apparatus 5 are included below with reference to FIGS. 2-6.

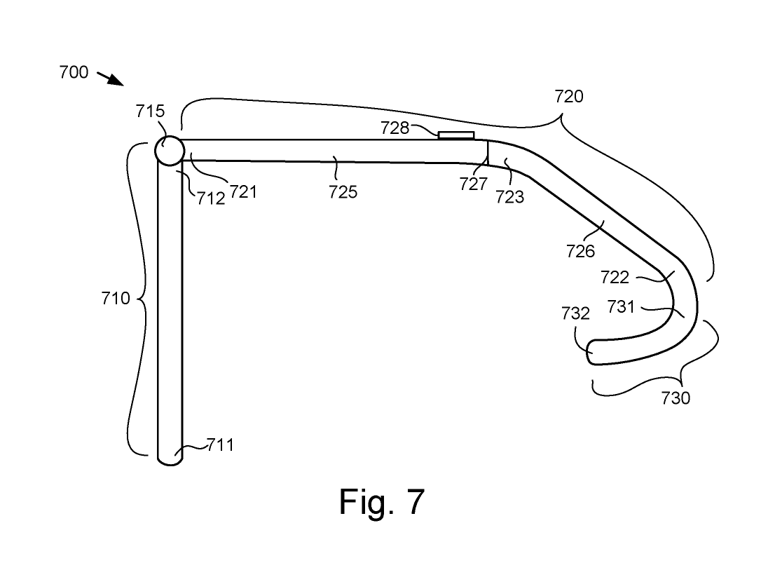

The apparatus 5 may be constructed of various materials, such as metal, plastic, composite fiber, etc. In one embodiment, the apparatus 5 may be a unitary cylindrical stock that has been shaped configured to have the above-mentioned sections 10, 20, 30. In another embodiment, the apparatus 5 may be constructed from separate pieces (e.g., sections 10, 20, 30) that are permanently coupled together. In one embodiment, the sections 10, 20, 30 may be detachably coupled together to allow user to breakdown and/or collapse the apparatus 5 for storage and/or transport. For example, each section 10, 20, 30 may be detachably coupled together via corresponding interlocking elements. As described in greater detail below, the junction between the handle section 110 and the transverse section 120 may be a pivoting joint mechanism 115 that allows a user to bend/collapse the apparatus 100 in order to fit the apparatus 100 into a suit-case or other transportation/storage container. In another embodiment, the junction between the transverse section 20 and the pressure point section 30 may also be a pivoting joint mechanism 115. In another embodiment, the junction between the transverse section 20 and the pressure point section 30 are detachably coupled with a joint that allow separation of the transverse section 20 from the pressure point section 30, which is described in more detail with regard the apparatus 700 of FIG. 7.

In one embodiment, as depicted in the figures, the transverse section 20 includes a bend 23 interposed between two subsections: a first subsection 25 that includes the first end 21 and a second subsection 26 that includes the second end 22. The bend 23 allows the second subsection 26 to extend from the first subsection 25 at an inward angle 24 relative to the first subsection 25. In one embodiment, the inward angle 24 is in the range of about 35 degrees (“°”) to about 90°. In another embodiment, the inward angle 24 is in the range of about 40° to 50°, which may facilitate positioning the apparatus 5 to extend past a body part and the pressure point section 30 to engage another body part. In another embodiment, the inward angle 24 is 45°. The bend 23 in the transverse section 20 may facilitate the proper positioning of the pressure point section 30 with respect to the body part of the user, as described below in greater detail. In one embodiment, the bend 23 may also include a pivoting joint mechanism 115 that allows the inward angle 24 to be selected based on a user's preference or may further improve the collapsibility and/or transportability of the apparatus. In one embodiment, the first subsection 25 of the transverse section 20 and handle section 10 are substantially perpendicular to each other. As seen in FIG. 1A, the junction between the transverse section 20 and the pressure point section 30 (i.e., the point where the second end 22 of the transverse section 20 is coupled to the distal end 31 of the pressure point section 30) is curved to allow the inward tip 32 of the pressure point section 30 to be directed towards the body part of the user that is to be massaged. This joint may be curved, as depicted, or the joint may be an abrupt change in direction.

Regarding the overall dimensions of the apparatus 5, it is expected that different implementations may have different dimensions in order to function for their intended purposes. For example, as described in greater detail below, depending on the body part to be massaged, the user may require an apparatus that has a comparatively longer transverse section 20. Accordingly, various relative dimensional characteristics of the apparatus 5 are described below to show the importance of the relative positions of certain sections/elements of apparatus 5 without specifically requiring the apparatus 5 to have specific dimensions.

In one embodiment, the handle section 10 has a length 13 and the inward tip 32 of the pressure point section 30 is disposed a distance 33 perpendicularly away from the first subsection 25 of the transverse section 20. According to one embodiment, the length 13 is greater than the distance 33. In another embodiment, the length 13 is at least 1.5 times the distance 33. In yet another embodiment, the length 13 is at least two times the distance 33. In other words, the free end 11 of the handle section 10 of the apparatus 5 is further removed from a longitudinal axis of the first subsection 25 of the transverse section 20 than the inward tip 32. Application of pressure by a user near the free end 11 of the handle section 10 allows pressure to be applied to a body part by the inward tip 32 at an angle such that the inward tip 32 continues to apply pressure rather than slipping upward. Application of pressure on the handle section 10 close to the attached end 12 or on the transverse section 20 applies pressure from the inward tip 32 in a more upward direction which may cause the inward tip 32 to slip and move up.

In one embodiment, the handle section 10 includes a gripping surface. For example, the handle section 10 may include a non-slip surface, bumps, finger grooves, and the like to allow a user to get a firm grip on the handle section 10 without slipping. In another embodiment, the handle section 10 includes a portion that has a larger diameter than other portions of the handle section 10. The larger diameter section, in one embodiment, is closer to the free end 11 and may allow the apparatus 5 to be used for various body parts, such as a foot, when the handle section 10 is extended to be in-line or extended with respect to the first subsection 25. Additional details relating to this embodiment are included below with reference to FIGS. 2-4.

In one embodiment, the inward tip 32 of the pressure point section 30 is disposed further away, in a direction parallel to the first subsection 25 of the transverse section 20, from the first end 21 of the transverse section 20 than the bend 23 is from the first end 21. In other words, a second distance 36 is greater than a first distance 35. In yet another embodiment, the junction between the distal end 31 of the pressure point section 30 and the second end 22 of the transverse section 20 is disposed further away, and a direction parallel to the first subsection 25 of the transverse section 20, from the first end 21 of the transverse section 20 than both the inward tip 32 and the bend 23. In other words, the third distance 37 is greater than the second distance 36 and the first distance 35.

In one embodiment, the inward tip 32 of the pressure point section 30 is parallel to the first subsection 25 of the transverse section 20. In another embodiment, the inward tip 32 of the pressure point section 30 is non-perpendicular to the second subsection 26 of the transverse section 20. In yet another embodiment, the handle section 10 is perpendicular to the inward tip 32 of the pressure point section 30. In one embodiment, the angle between the handle section 10 and the transverse section 20 is substantially 90°. However, in other embodiments, the apparatus 5 may be constructed so that the angle between the handle section 10 and the transverse section 20 may be different than 90° or may vary. For example, in one embodiment the junction between the handle section 10 and the transverse section 20 may be a pivoting joint mechanism 115 (see FIG. 1B) that allows the user to select the angle between the handle section 10 and the transverse section 20.

FIG. 1B is a side view of another embodiment of the massage apparatus 100 for applying pressure to the body part of the user. As mentioned above, the point where the attached end 112 of the handle section 110 is coupled to the first end 121 of the transverse section 120 may be a pivoting joint mechanism 115. In other words, the handle section 110 in the transverse section 120 may be coupled together via a pivotable mechanism that allows the user to select the extension direction of the handle section 110 with respect to the transverse section 120. Thus, according to one embodiment, the angle 114 between the handle section 110 and at least the first subsection 125 of the transverse section 120 is adjustable. This feature may allow the user greater flexibility in positioning the apparatus 100 about the body part in order to more accurately apply a specific massaging force to a specific point of the body part.

In one embodiment, the pivoting joint mechanism 115 may be spring loaded/actuated to allow the user to easily select the angle 114 between the handle section 110 and the transverse section 120. For example, the joint mechanism 115 may include spring-loaded pins that are received into corresponding recesses/boreholes to lock the handle section 110 in predetermined positions. In one embodiment, the joint mechanism 115 may include a ratcheting mechanism that allows the handle section 110 to be locked in various discrete extension directions with respect to the transverse section 120.

In one embodiment, the pivoting joint mechanism 115 may include two plates, one coupled to the attached end 112 of the handle section 110 and the other attached to the first end 121 of the transverse section, that have engagement surfaces that face each other and contact each other when assembled. A central hub or axle may extend between the two plates about which the handle section 110 and the transverse section 120 pivot. One of the plates may have grooves/slots, such as an apertures or recesses, that receive corresponding protrusions, such as pins or channel bumps. Such a configuration of the pivoting joint mechanism 115 may include a spring assembly that biases the plates so as to be passively maintained in firm locking engagement by aligning the grooves with the corresponding protrusions. Accordingly, the number and spatial configuration of the grooves and corresponding protrusions on the plates may be related to the number and degree of the angular locked positions that the apparatus may assume. User may then grasp one or both of the plates and exert a force to separate the plates a distance from each other, thus allowing the plates to be rotated relative to each other in order to select a different angular locked position, thereby choosing the angle 114 between the handle section 110 and the transverse section 120. In one embodiment, the plates may include handles or other such grip enhancements that enable the user pull the plates apart to change the relative angular position of the handle section 110 and the transverse section 120. In one embodiment, the pivoting joint mechanism 115 may include stop features that restrict the angle 114.

As described above with reference to FIG. 1A, the specific dimensions of the apparatus 100 may differ depending on a specific implementation that is configured for a specific body part to be massaged. In one embodiment, the handle section 110 has a length 113 and the inward tip 132 of the pressure point section 130 is disposed a distance 133 perpendicularly away from the first subsection 125 of the transverse section 120. According to one embodiment, the length 113 is a greater than the distance 133. In another embodiment, the length 113 is at least 1.5 times the distance 133. In yet another embodiment, the length 113 is at least two times the distance 133. In other words, the free end 111 of the handle section 110 of the apparatus 100 is further removed from a longitudinal axis of the first subsection 125 of the transverse section 120. Additional details relating to this embodiment are included below with reference to FIGS. 2-4.

In one embodiment, the inward tip 132 of the pressure point section 130 is disposed further away, in a direction parallel to the first subsection 125 of the transverse section 120, from the first end 121 of the transverse section 120 than the bend 123 is from the first end 121. In other words, a second distance 136 is greater than a first distance 135. In yet another embodiment, the junction between the distal end 131 of the pressure point section 130 and the second end 122 of the transverse section 120 is disposed further away, and a direction parallel to the first subsection 125 of the transverse section 120, from the first end 121 of the transverse section 120 than both the inward tip 132 and the bend 123. In other words, the third distance 137 is greater than the second distance 136 and the first distance 135.

In one embodiment, the inward tip 132 of the pressure point section 130 is parallel to the first subsection 125 of the transverse section 120. In another embodiment, the inward tip 132 of the pressure point section 130 is non-perpendicular to the second subsection 126 of the transverse section 120. In yet another embodiment, the pivoting joint mechanism 115 may be actuated so that the handle section 110 is perpendicular to the inward tip 132 of the pressure point section 130.

In one embodiment, the handle section 110, the transverse section 120 and the pressure point section 130 are all substantially coplanar. Hereinafter “substantially coplanar” means that the handle section 110, the transverse section 120 and the pressure point section 130 are typically coplanar but that some minor variation may exist, such as the pressure point section 130 may be rotated slightly to either side of the plane that the handle section 110 and the transverse section reside within. In another embodiment, the handle section 110, the transverse section 120 and the pressure point section 130 are coplanar.

FIG. 2 is a side view of one embodiment of the massage apparatus 100 positioned around the body part 50 of the user. The body part 50 may be any of various body parts of the user. Throughout the figures of the present disclosure, a user is shown grasping the handle section 110 (positioned near the front 51 of the user) of the apparatus 100 and positioning the transverse section 120 to extend over/around the shoulder of the user in order to massage the user's back 52 with the pressure point section 130. However, in other embodiments, the apparatus 100 may be used to massage body parts other than the user's back. For example, the apparatus 100 may be used to massage the bottom/souls of the user's feet. In another embodiment, the apparatus 100 may be used to massage/apply pressure to an underside or backside of the user's legs. Thus, it is expected that the apparatus 100 may be used in a plurality of different configurations in order to massage various body parts.

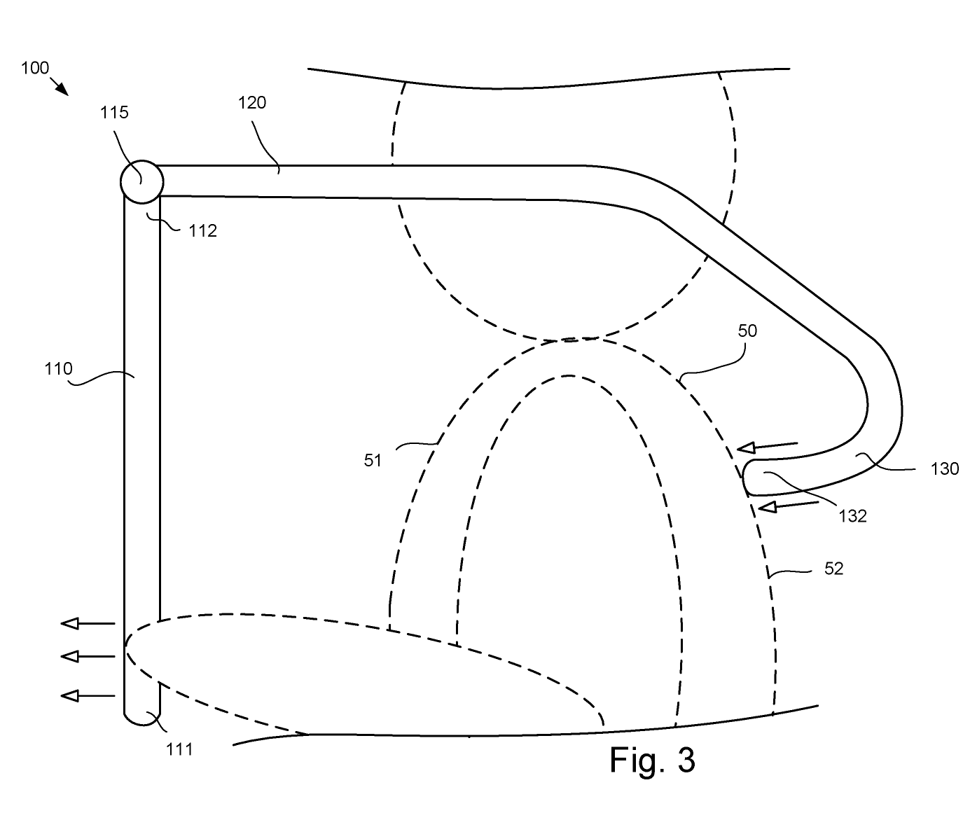

In the embodiment depicted in FIG. 2, the user grasps the handle section 110 and applies a force in a direction outwards and away from the front side 51 of the body part 50. This force is translated/conveyed through the apparatus 100 and the inward tip 132 of the pressure point section 130 applies a desired massaging force/pressure to the backside 52 of the body part 50. The relative dimensions of the apparatus 100 and the position along the handle section 110 where the user grasps are important factors in determining the type, magnitude, and direction of the massaging force applied to the back 52 of the body part 50. Accordingly, various illustrative examples are shown and described with reference to FIGS. 3-6.

FIG. 3 is a side view of another embodiment of the massage apparatus 100 positioned around the body part of the body 50 the user. In the depicted embodiment, the user grasps the handle section 110 near the free end 111 and applies an outward force. Since the length 113 (see FIG. 1B) of the handle section 110 (i.e., the distance of the free end 111 away from the pivoting joint mechanism 115) is comparatively greater than the distance 133 between the inward tip 132 and the first subsection 125 of the transverse section 120 (i.e., the free end 111 is lower than the inward tip 132), the massaging force on the backside 52 of the body part 50 is directed straight into or slightly downward towards the back surface 52 of the body part 50. In such an embodiment, the inward tip 132 is prevented from inadvertently sliding up the backside 52 of the body part 50. Therefore, because of the relative length 113 of the handle section 110 with respect to the distance 133 of the inward tip 132, the user is able to selectively grasp the handle section at any point along its length to adjust and control the direction of the massaging force on the backside 52 of the body part 50.

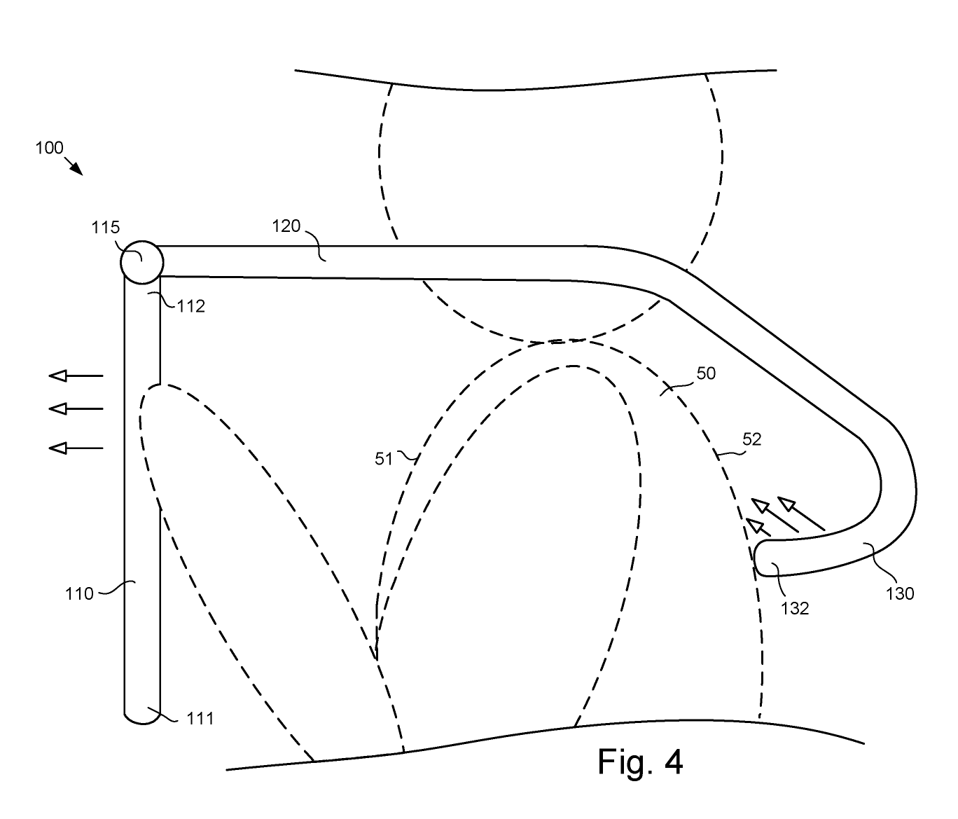

For example, as seen in FIG. 4, the user may grasp the handle section 110 a location near the attached end 112. In such a situation, the force translated along the apparatus 100 to the inward tip 132 causes an upward/sliding massaging force to be applied to the backside 52 of the body part 50. In certain situations, this type of massaging force may not be desired, as a user may want to use the apparatus 100 to apply and even and/or non-sliding massaging force to a specific point on the backside 52 of the body part 50. For example, when massaging a user's back, the inward tip 132 may be positioned against a certain vertebrae and/or muscle of the back in the user may desire to only apply a point-type pressure to the location. In such an embodiment, the user would need to grasp the handle section 110 of the apparatus 100 at a position near the free end 111 (e.g., the grasping location depicted in FIG. 3).

The inward tip 132 of the pressure point section 130 may be configured to have a certain shape. For example, the inward tip 132 may have a dome-shaped that is well-suited for massaging certain muscles of a body part. In another embodiment, the inward tip may have other exterior surface profiles. Further, the inward tip 132 may be configured so that optional massaging heads may be attached thereto, thereby allowing the user greater flexibility during the administration of the personal massage. For example, a head may be attached to the inward tip 132 that includes various protrusions and/or bumps that provide an invigorating rub to the body part 50. In another embodiment, a powered vibrating head or a temperature controlled head may be attached to the inward tip 132.

In one embodiment, the inward tip 132 may be removable where a variety of massaging heads may be attached. For example, massaging heads may include various shapes and diameters. For example, a more pointed massaging head may be used to provide a more directed pressure where a flatter and/or bigger massaging head may provide a more diffuse pressure. In another embodiment, various materials may be used for the massaging head. For example, some massaging heads may be of a rigid material, some may be semi-rigid, some may be firm, some may be soft, etc. In some embodiments, a massaging head may include a non-slip surface that aids in keeping the inward tip 132 in a particular position. Other massaging heads may have various ridges, bumps, protrusions, and the like. One of skill in the art will recognize other shapes for a massaging head.

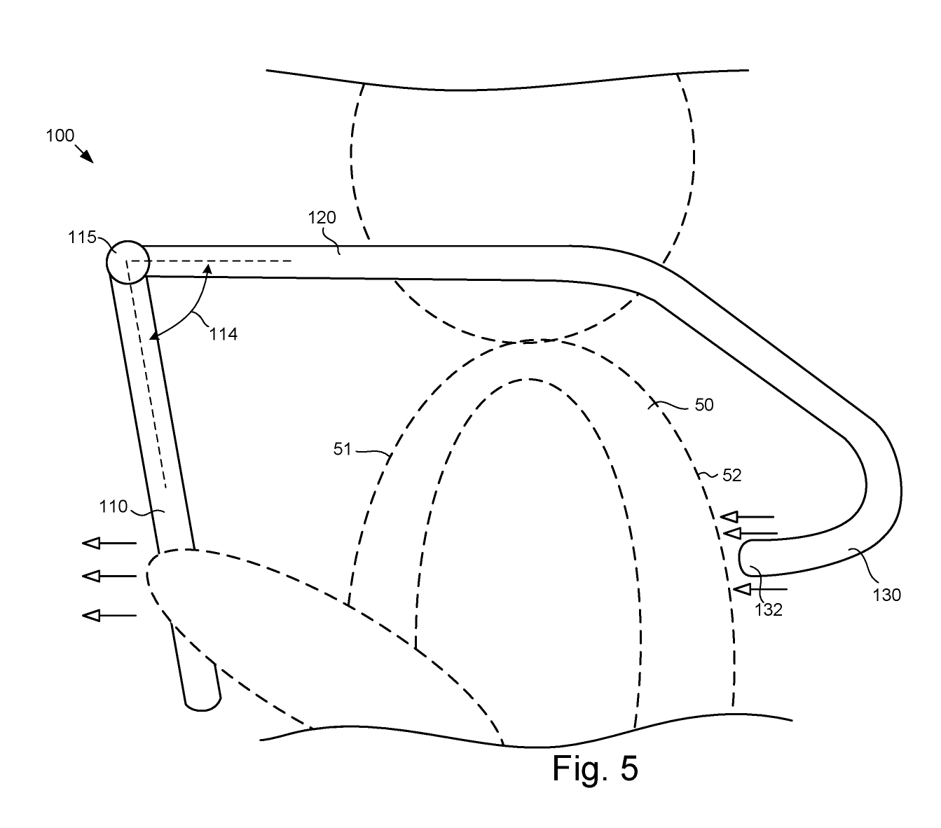

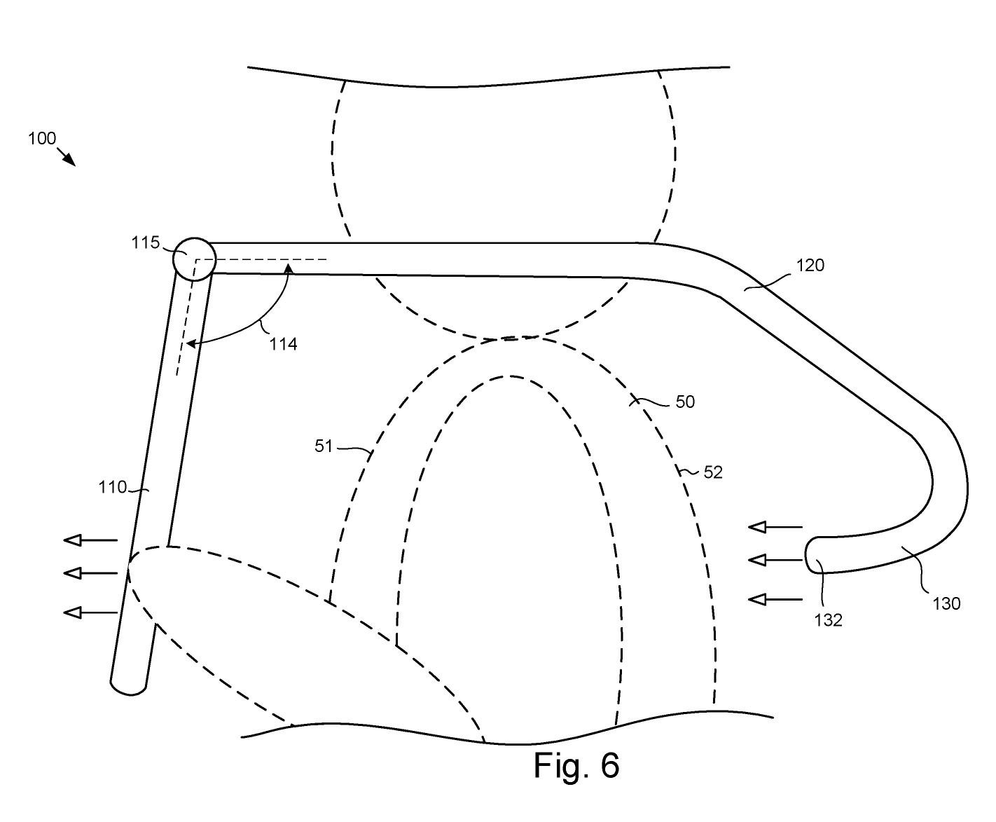

FIG. 5 is a side view of another embodiment of the massage apparatus 100 positioned around the body part 50 of the user. FIG. 5 shows the handle section 110 extending from the transverse section 120 at an acute angle 114. As described above, the pivoting joint mechanism 115 may be actuated to have the depicted angle 114. FIG. 6 shows a similar embodiment where the pivoting joint mechanism 115 has been actuated to have an obtuse angle. Thus, the pivoting joint mechanism 115 provides greater flexibility to the type and direction of the massaging force applied to the backside 52 of the body part 50. Further, the pivoting joint mechanism 115 may allow the user to massage a plurality of different body parts that would otherwise not be massagable without the customizability of the pivoting joint mechanism 115.

FIG. 7 is a side view of another embodiment of a massage apparatus 700 for applying pressure to the body part of a user. As discussed above in relation to the apparatuses 5 and/or 100, the apparatus 700 may include a handle section 710, which may include a free end 711 and/or an attached end 712. The point where the attached end 712 of the handle section 710 is coupled to the first end 721 of the transverse section 720 may be a pivoting joint mechanism 715 as described above in relation to pivoting joint mechanism 115.

The transverse section 720 includes a first end 721 and a second end 722. The attached end 712 of the handle section 710 is coupled to the first end 721 of the transverse section 720. The massage apparatus 700 further includes a pressure point section 730. The pressure point section 730 is the portion of the apparatus 700 that is directed towards and engages with a surface of the body part being massaged. Specifically, the pressure point section 730 includes a distal end 731 and an inward tip 732. The second end 722 of the transverse section 720 is coupled to the distal end 731 of the pressure point section 730. The inward tip 732 is the element that contacts and applies pressure to the body part when the user grasps the handle section and applies a force the apparatus 700.

In one embodiment, as depicted in the figures, the pressure point section 730 includes a bend 723 interposed between two subsections: a first subsection 725 that includes the first end 721 and a second subsection 726 that includes the second end 722. The bend 723 allows the second subsection 726 to extend from the first subsection 725 at an inward angle 724 relative to the first subsection 725.

In one embodiment, the second subsection 726 may be removable from the first subsection 725. For example, an end of the second subsection 726 located distal from the pressure point section 730 may insert into an inserting aperture 727 of the first subsection 725 located distal from the first end 721. The apparatus 700 may include a release mechanism 728. A user interacting with the release mechanism 728 may include releasing the second subsection 726 from the inserting aperture 727 of the first subsection 725. Releasing the second subsection 726 may include decoupling, disconnecting, or the like the second subsection 726 from the first subsection 725 and allow a user to remove the second subsection 726.

In one embodiment, the end of the second subsection 726 that is insertable into the inserting aperture 727 may include one or more features that couple to the inside of an end of the first subsection 725. For example, in one embodiment, the end of the second subsection 726 may include one or more grooves, holes, or the like for receiving a securing portion of the end of the first subsection 725. The end of the first subsection 725 may include one or more protrusions that engage with the one or more grooves or holes of the second subsection 726. The one or more protrusions engaging with the one or more grooves or holes of the second subsection 726 may couple the second subsection 726 to the first subsection 725.

In one embodiment, the apparatus 700 may include a release mechanism 728. The release mechanism 728 may be connected to the first subsection 725 or the second subsection 726. A user may interact with the release mechanism 728 and release the second subsection 726 from the first subsection 725. For example, in one embodiment, the release mechanism 728 may include a button. A user may press the button and one or more components of the first subsection 725 may move the one or more protrusions of the first subsection 725 away from the one or more grooves or holes of the second subsection 726. Moving the one or more protrusions away from the one more grooves or holes may allow a user to adjust, reposition, move, or the like the second subsection 726 inside the first subsection 725, as explained below. In another embodiment, the release mechanism 728 may include a screw. A user may turn the screw and the screw may move the one or more protrusions away from the one or more grooves or holes. In a further embodiment, an end of the screw may include the one or more protrusions that protrude into the one or more grooves or holes. One of skill in the art will recognize other forms that the release mechanism 728 may include that a user may interact with and that may release the second subsection 726 from the first subsection 725.

In one embodiment, as mentioned above, the second subsection 726 may be adjustable within the first subsection 725. For example, the second subsection 726 may include multiple grooves and the one or more protrusions may protrude into different grooves or holes to couple the second subsection 726 to the first subsection 725 in multiple positions. In a first position, for example, the second subsection 726 may extend away from the first subsection 725 further than in a second position. The different positions may allow a user to adjust the apparatus 700 and massage different body parts. In one embodiment, the different positions may allow the apparatus 700 to adjust for different users. Also, by detaching the second subsection 726 of the transverse section 720 and the pressure point section 730 from the first subsection 725 of the transverse section 720 and folding the handle section 710 close to the first subsection 725 of the transverse section 720, the apparatus 700 may be more portable, for example for carrying on an airplane.

In one embodiment where the release mechanism 728 may include a button, a user may interact with the button to adjust the position of the second subsection 726 within the first subsection 725. For example, in one embodiment, the user may press and release the button and, in response, the one or more protrusions may disengage from the one or more grooves, holes, or the like of the second subsection 726 and allow the user to move the second subsection 726 away from the first subsection 725, including allowing the user to remove the second subsection 726 from the first subsection 725. Pressing and releasing the button may allow the second subsection 726 to move toward the first subsection 725 and/or retract into the first subsection 725. In one embodiment, the user may press and hold the button while adjusting the second subsection 726 inside the first subsection 725 and the user may release the button to stop adjusting the second subsection 726.

In one embodiment, the release mechanism 728 may include a wheel. A user may rotate the wheel to adjust the second subsection 726 within the first subsection 725. For example, in one embodiment, rotating the wheel toward the first end 721 of the transverse section 720 may move the second subsection 726 toward the first subsection 725. Rotating the wheel away from the first end 721 may move the second subsection 726 away from the first subsection 725. In one embodiment, rotating the wheel and moving the second subsection 726 away from the first subsection 725 may disconnect or decouple the second subsection 726 from the first subsection 725. The wheel may be mounted to the apparatus 700 at any location, including, but not limited to, partially inside the apparatus 700. The partially exposed wheel may allow a user to adjust the second subsection 726 while maintaining the compactness of the apparatus 700.

In one embodiment, the second subsection 726 may insert into the first subsection 725 at one or more rotatable positions. For example, in one embodiment, the second subsection 726 may insert into the first subsection 725 in a first position that includes the second subsection 726 extending downward and parallel to the handle section 710, as shown in FIG. 7. The second subsection 726, in another example, may insert into the first subsection 725 in a second position that includes the second subsection 726 extending toward a left side and perpendicular to the handle section 710. In one embodiment, the second subsection 726 may rotatably insert into the first subsection 725 at any rotatable position and/or angle. In another embodiment, the second subsection 726 may rotatably insert into the first subsection 725 at one or more predetermined positions and/or angles. In one embodiment, the second subsection 726 may rotate while inserted inside the first subsection 725.

In one embodiment, a powered vibrating head or a temperature controlled head may be attached to or mounted to the inward tip 732. A power source for the head may be mounted to the handle section 710 or the first subsection 725 and may provide power to the head. The power source may provide power to the head through one or more cables, wires, or the like. In one embodiment, the second subsection 726 coupling with the first subsection 725 may include coupling a portion of the one or more cables of the first subsection 725 to a portion of the one or more cables of the second subsection 276.

In one embodiment, the apparatus 700 may include multiple second subsections 726 and/or multiple pressure point sections 730. The multiple pressure point sections 730 may each include an inward tip 732 different from the other inward tips 732 of the other pressure point sections 730. For example, as mentioned above, in one embodiment, a first inward tip 732 may have a dome-shaped that is well-suited for massaging certain muscles of a body part and a second inward tip 732 may include various protrusions and/or bumps that provide an invigorating rub to a body part. The multiple inward tips 732 may also be replaceable and allow a user to replace one or more inward tips 732 without purchasing a replacement massage apparatus 700. In one embodiment, an inward tip 732 may be covered with a sanitary plastic cover.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A massage apparatus for applying pressure to a body part of a user, the massage apparatus comprising:
a handle section configured to be positioned on a first side of the body part, the handle section comprising a free end and an attached end;
a transverse section configured to extend from the first side of the body part to a second side of the body part, the transverse section comprising a first end positionable on the first side of the body part and a second end positionable on the second side of the body part, wherein the first end of the transverse section is coupled to the attached end of the handle section; and
a pressure point section configured to apply pressure to the body part, the pressure point section comprising a distal end and an inward tip, wherein the distal end of the pressure point section is coupled to the second end of the transverse section and the inward tip is engageable on the body part.

2. The massage apparatus of claim 1, wherein the transverse section comprises a bend interposed between two subsections: a first subsection comprising the first end and a second subsection comprising the second end, wherein the second subsection extends from the first subsection at an inward angle.

3. The massage apparatus of claim 2, wherein the inward angle is about 45 degrees.

4. The massage apparatus of claim 3, wherein the first subsection of the transverse section and the handle section are substantially perpendicular.

5. The massage apparatus of claim 2, wherein the handle section comprises a length and the inward tip of the pressure point section is disposed a distance perpendicularly away from the first subsection of the transverse section, wherein the length is greater than the distance.

6. The massage apparatus of claim 5, wherein the length is at least 1.5 times the distance.

7. The massage apparatus of claim 5, wherein the length is at least 2.0 times the distance.

8. The massage apparatus of claim 2, wherein the inward tip of the pressure point section is disposed further away, in a direction parallel to the first subsection of the transverse section, from the first end of the transverse section than the bend is from the first end of the transverse section.

9. The massage apparatus of claim 2, wherein the inward tip of the pressure point section is parallel to the first subsection of the transverse section.

10. The massage apparatus of claim 2, wherein the inward tip of the pressure point section is non-perpendicular to the second subsection of the transverse section.

11. The massage apparatus of claim 1, wherein the handle section is perpendicular to the inward tip of the pressure point section.

12. The massage apparatus of claim 1, further comprising a pivoting joint mechanism intercoupled between the attached end of the handle section and the first end of the transverse section, wherein the pivoting joint mechanism is configured to allow the user to select an angle between the handle section and the transverse section.

13. A massage apparatus for applying pressure to a body part of a user, the massage apparatus comprising:
a handle section configured to be positioned on a first side of the body part, the handle section comprising a free end and an attached end;
a transverse section configured to extend around from the first side of the body part to a second side of the body part, the transverse section comprising a first end positionable on the first side of the body part and a second end positionable on the second side of the body part, the transverse section comprising a bend interposed between two subsections: a first subsection comprising the first end and a second subsection comprising the second end, wherein the second subsection extends from the first subsection at an inward angle;
a pivoting joint mechanism intercoupled between the attached end of the handle section and the first end of the transverse section, wherein the pivoting joint mechanism is configured to allow the user to select an angle between the handle section and the transverse section; and
a pressure point section configured to apply pressure to the body part, the pressure point section comprising a distal end and an inward tip, wherein the distal end of the pressure point section is coupled to the second end of the transverse section and the inward tip is engageable on the body part,
wherein the handle section comprises a length and the inward tip of the pressure point section is disposed a distance perpendicularly away from the first subsection of the transverse section, wherein the length is greater than the distance, and
wherein the inward tip of the pressure point section is disposed further away, in a direction parallel to the first subsection of the transverse section, from the first end of the transverse section than the bend is from the first end of the transverse section.

14. The massage apparatus of claim 13, further comprising a joint detachably coupling the first subsection of the transverse section to the second subsection of the transverse section.

15. The massage apparatus of claim 14, wherein the joint further comprises a release mechanism, wherein engaging the release mechanism releases the first subsection of the transverse section from the second subsection of the transverse section.

16. The massage apparatus of claim 14, wherein the joint comprises a coupling mechanism that detachably couples the second subsection to the first subsection at various angles with respect to a plane extending through the first subsection of the transverse section and the handle section.

17. The massage apparatus of claim 14, further comprising a plurality of pressure point sections, each pressure point section comprising a different inward tip.

18. The massage apparatus of claim 13, further comprising a tip coupling joint and a plurality of different inward tips, wherein each inward tip is coupleable to the pressure point section at the tip coupling joint.

19. The massage apparatus of claim 18, wherein an inward tip of the plurality of different inward tips comprises one or more of a temperature controlled inward tip, a vibrating inward tip, a pointed tip, a soft tip and a rounded tip.

20. A massage apparatus for applying pressure to a body part of a user, the massage apparatus comprising:
a handle section configured to be positioned on a first side of the body part, the handle section comprising a free end and an attached end;
a transverse section configured to extend from the first side of the body part to a second side of the body part, the transverse section comprising a first end positionable on the first side of the body part and a second end positionable on the second side of the body part, the transverse section comprising a bend interposed between two subsections: a first subsection comprising the first end and a second subsection comprising the second end, wherein the second subsection extends from the first subsection at an inward angle;
a pivoting joint mechanism intercoupled between the attached end of the handle section and the first end of the transverse section, wherein the pivoting joint mechanism is configured to allow the user to select an angle between the handle section and the transverse section;
a pressure point section configured to apply pressure to the body part, the pressure point section comprising a distal end and an inward tip, the inward tip is engageable on the body part, the inward tip of the pressure point section parallel to the first subsection of the transverse section; and
a joint detachably coupling the first subsection of the transverse section to the second subsection of the transverse section,
wherein the handle section comprises a length and the inward tip of the pressure point section is disposed a distance perpendicularly away from the first subsection of the transverse section, wherein the length is greater than the distance, and
wherein the inward tip of the pressure point section is disposed further away, in a direction parallel to the first subsection of the transverse section, from the first end of the transverse section than the bend is from the first end of the transverse section.
